(19) United States
(12) Patent Application Publication
(10) Pub. No.: US 2009/0162157 A1
(43) Pub. Date: Jun. 25, 2009

(54) PROCESSING MACHINE

(75) Inventors: Yukitaka MAKINO, Suzuka-shi (JP); Toshiki Hirukawa, Kuwana-shi (JP); Hideki Hayashi, Yokkaichi-shi (JP); Keisuke Murayama, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/340,801

(22) Filed: Dec. 22, 2008

(30) Foreign Application Priority Data
Dec. 25, 2007 (JP) 2007-332458

(51) Int. Cl. B23B 51/06

(52) U.S. Cl. 408/56

(57) ABSTRACT

A processing machine has a main spindle apparatus and a tool holder which clamps a working tool. The main spindle apparatus detachably supports the tool holder and rotates. Oil mist is transported to the working tool through a lubricant supplying pipe in the main spindle apparatus. A coolant hose is formed in the tool holder. A supporting member is composed mainly of a sleeve and a draw bar. The supporting member air-tightly supports the coolant hose of the tool holder. A ring-shaped packing is placed between the lubricant supplying pipe and the supporting member in order to prevent any leakage of the oil mist. The periphery of the packing has two divided sub-parts of a character “Y” shape. The leaking oil mist expands one sub-part of the packing to air-tightly seal the gap formed between the lubricant supplying pipe and the draw bar.

### CROSS-REFERENCE TO RELATED APPLICATION

This application is related to and claims priority from Japanese Patent Application No. 2007-332458 filed on Dec. 25, 2007, the contents of which are hereby incorporated by reference.

### BACKGROUND OF THE INVENTION

1. Field of the Invention

The present invention relates to a processing machine equipped with a main spindle apparatus for working tools (or machine tools) and a tool holder. The tool holder clamps a machine tool for processing a target work. The main spindle apparatus detachably clamps the tool holder and rotates the tool holder while clamping the tool holder.

2. Description of the Related Art

There is a conventional main spindle apparatus as one of the processing machines. For example, Japanese patent laid open publication No. JP 2007-307689 has disclosed such a conventional main spindle apparatus.

The conventional main spindle apparatus works a target work piece while supplying oil mist as a cooling lubricant to the working tool. The cooling lubricant both cools and lubricates the working tool such as a cutting tool.

In the conventional main spindle apparatus disclosed in JP 2007-307689, a tool holder, that clamps a working tool, is inserted to the front end of the main spindle apparatus. In the main spindle apparatus, a bearing member rotatably supports an oil mist supplying pipe to a main spindle member. The oil mist is supplied to the working tool through the oil mist supplying pipe.

On processing the target work piece by a predetermined procedure, the main spindle apparatus controls the oil mist supplying pipe to decrease its rotation speed rather than that of the main spindle. This rotation control prevents adhesion of the oil mist to the inner peripheral surface of the oil mist supplying pipe. The oil mist supplying pipe is placed in a through hole formed in the main spindle member. Further, this rotation control supplies an adequate amount of the oil mist to an inner sleeve and the working tool without decreasing a necessary amount of the oil mist, while suppressing vibration and deflection generated in the oil mist supplying pipe, thereby avoiding breaking the inner sleeve, a draw bar, and other components.

By the way, there is another type of the main spindle apparatus and the tool holder for working tools (as called to as the “HSK type”) In this type of the main spindle machine, the front end of the oil mist supplying pipe is inserted into an axial hole formed in the tool holder, through which oil mist is supplied. Such a type of the main spindle apparatus and the holder requires, in order to permit installation and removal of the tool holder, an adequate gap between the outer peripheral surface of the front end part of the oil mist supplying pipe and the inner peripheral surface of the axial hole of the tool holder. However, the oil mist supplied from the front end of the oil mist supplying pipe leaks out to the outside of the processing machine through the gap between the oil mist supplying pipe and the tool holder. This makes it difficult to supply the adequate amount of the oil mist to the tool.

### SUMMARY OF THE INVENTION

It is an object of the present invention to provide a processing machine equipped with a main spindle apparatus and a tool holder clamping a working tool (or a machine tool), capable of supplying an adequate amount of a cooling lubricant such as oil mist to the working tool.

To achieve the above purposes, the present invention provides a processing machine having a main spindle apparatus and a tool holder. The main spindle apparatus detachably supports and air-tightly clamps the tool holder. The main spindle apparatus rotates while clamping the tool holder with a working tool. The main spindle apparatus has a main spindle part, a lubricant supplying pipe, and a supporting member. The main spindle part is driven to rotate, and has a through hole part that is formed along the axis of rotation of the main spindle part. The lubricant supplying pipe is placed in the through hole part. Through the lubricant supplying pipe, a cooling lubricant is transported to the working tool. The supporting member rotates together with the main spindle part and supports and air-tightly clamps a part of the tool holder. The tool holder clamps the working tool which processes a work piece. The tool holder has a locked member, a holder main part, and an axial hole. The locked member is formed at one end part of the tool holder, and is air-tightly clamped by the supporting member. The holder main part is formed at the other end part of the tool holder, and clamps the working tool. The axial hole transports the cooling lubricant to the working tool. The axial hole is formed from one end part to the other end part of the tool holder along the axis of rotation of the holder main part. A front end part of the axial hole is inserted and fitted to the inside of the main spindle apparatus when the main spindle apparatus clamps the tool holder. In the processing machine, a leakage preventing member of a ring shape capable of preventing leakage of the cooling lubricant is placed at least one of between the supporting member and the lubricant supplying pipe and between the axial hole of the tool holder and the lubricant supplying pipe.

From the viewpoint that the tool holder is detachable to the main spindle apparatus, it is required to have a gap between the outer peripheral surface of the front end part of the lubricant supplying pipe and the inner peripheral surface of the axial hole of the tool holder. Forming the gap between the outer peripheral surface of the lubricant supplying pipe and the inner peripheral surface of the axial hole of the tool holder introduces a possibility of the cooling lubricant such as oil mist leaking through this gap. In order to avoid such a problem, the structure of the processing machine according to the present invention is equipped with at least one leakage preventing member. Using the leakage preventing member avoids any leakage of the cooling lubricant through the gap, and provides an adequate amount of the cooling lubricant to the working tool so as to cool and lubricate it. That is, when the leakage preventing member of a ring shape is placed between the axial hole and the lubricant supplying pipe, the leakage preventing member can prevent any leakage of the cooling lubricant through the gap, and it is therefore possible to supply an adequate amount of the cooling lubricant to the working tool.

On the other hand, when the leakage preventing member is placed between the supporting member and the lubricant supplying pipe, there is also a possibility of the cooling lubricant leaking through the gap. However, the action of the supporting member for air-tightly supporting a part of the tool holder, and the presence of the leakage preventing member between the supporting member and the lubricant supplying pipe can control the amount of the cooling lubricant leaking even if the lubricant leaks through the gap. This can guarantee to provide the adequate amount of the cooling lubricant to the working tool.

In the processing machine as another aspect of the present invention, the leakage preventing member of a ring shape has an opening part, and is deformed to decrease the diameter of the opening part (will be referred to also as the “opening diameter”) according to increasing the amount of the cooling lubricant, namely, a pushing force applied by the cooling lubricant. The opening diameter of the leakage preventing member is decreased according to increasing the amount of the leaking lubricant. This feature of the leakage preventing member enhances the leakage preventing effect.

In the processing machine as another aspect of the present invention, the leakage preventing member has a divided part comprised of at least two divided sub-parts. The leakage preventing member is placed so that the divided sub-parts face the supplying direction of the cooling lubricant, and at least one divided sub-part is inclined to the supplying direction of the cooling lubricant. This structure of the leakage preventing member decreases its opening diameter according to increasing the amount of the leaking lubricant.

In the processing machine as another aspect of the present invention, the leakage preventing member is composed of an O-ring. This can also prevent the leakage of the cooling lubricant, and supply an adequate amount of the cooling lubricant to the working tool.

### BRIEF DESCRIPTION OF THE DRAWINGS

A preferred, non-limiting embodiment of the present invention will be described by way of example with reference to the accompanying drawings, in which:

FIG. 1 is a partially sectional schematic view of a processing machine according to a first embodiment of the present invention;

FIG. 2 is an enlarged sectional view of a packing as a leakage preventing member and its peripheral part in the processing machine according to the first embodiment of the present invention;

FIG. 3 is a plan view of the packing to be assembled into the processing machine according to the first embodiment of the present invention;

FIG. 4 is a sectional view of the packing to be assembled into the processing machine according to the first embodiment along IV-IV line in FIG. 3;

FIG. 5 is an enlarged typical sectional view of the packing and its peripheral parts in the processing machine according to a second embodiment of the present invention; and

FIG. 6 is an enlarged sectional view of another configuration of the packing and its peripheral parts in the processing machine according to the second embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

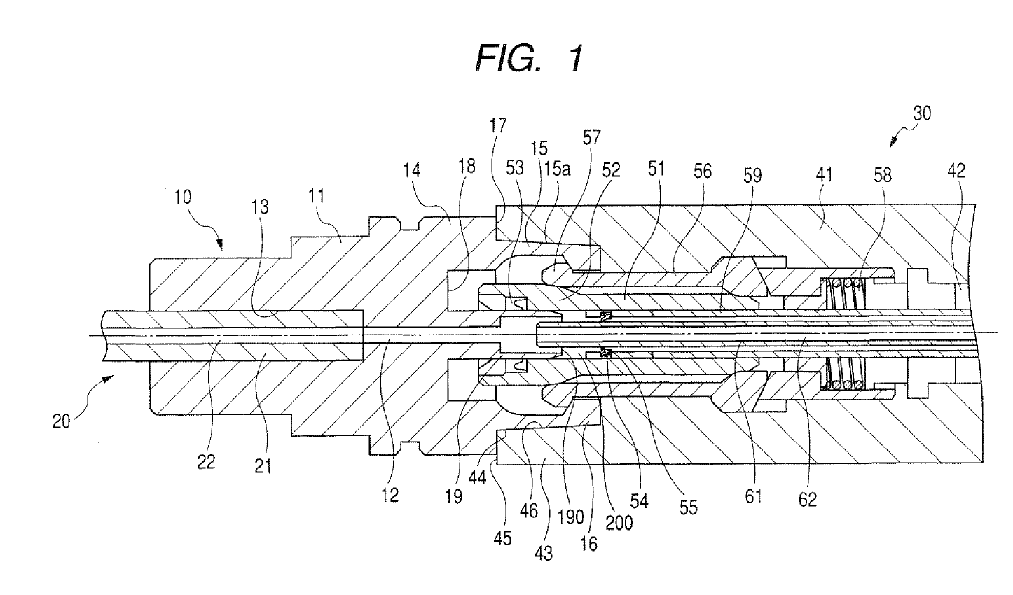

A description will be given of the processing machine equipped with the main spindle apparatus and the tool holder according to the first embodiment of the present invention with reference to FIG. 1 to FIG. 4.

FIG. 1 is a partially sectional schematic view of the processing machine according to the first embodiment of the present invention. FIG. 1 shows a schematic cross section of a front end part of the main spindle apparatus 30, which is cut in a plane along a rotary shaft of the main spindle. The main spindle apparatus 30 clamps the tool holder 10. The tool holder 10 also clamps a working tool 20 (or a machine tool such as a cutting tool).

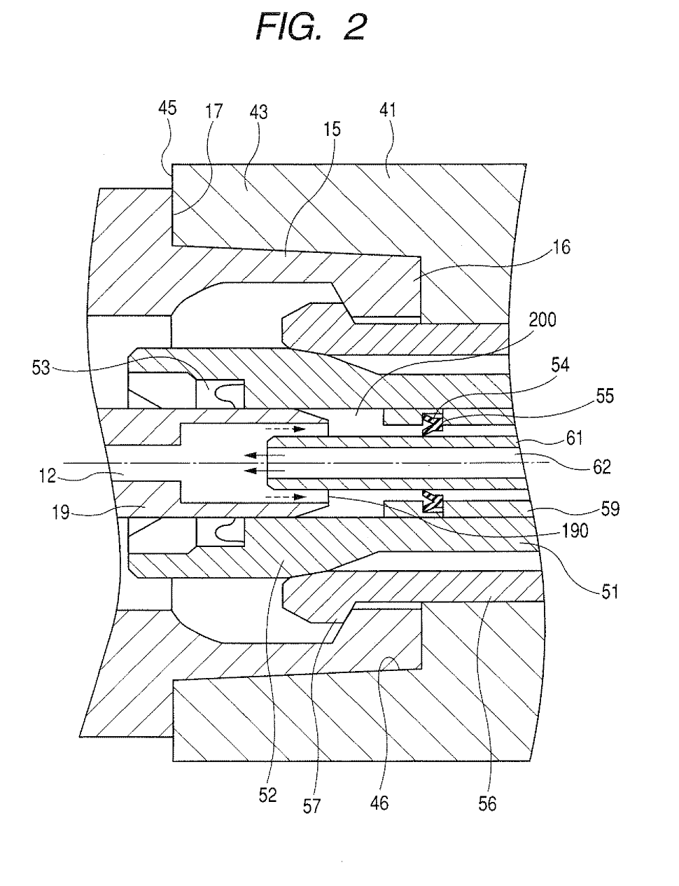

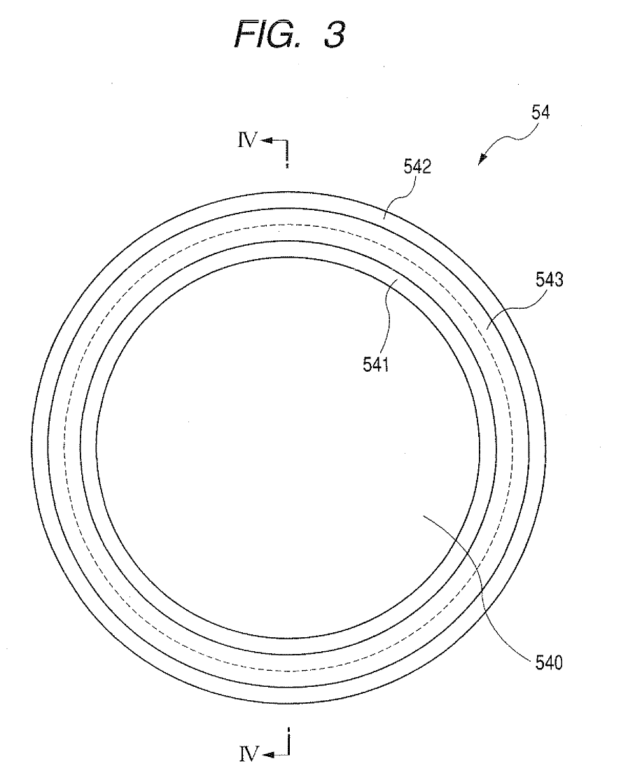

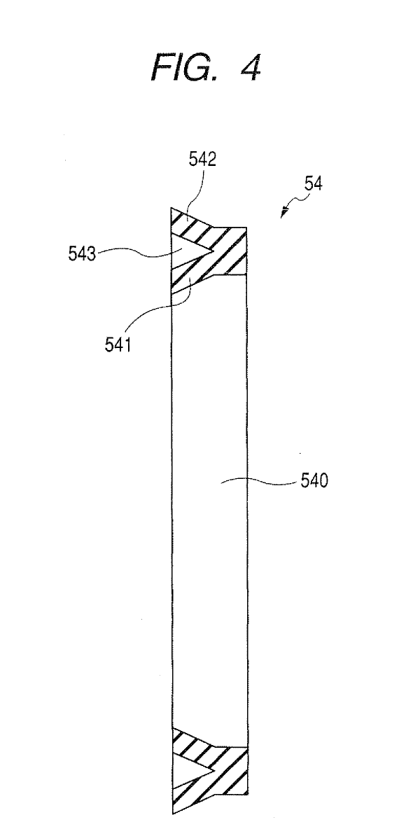

FIG. 2 is an enlarged sectional view of a packing 54 as a leakage preventing member and its peripheral part in the processing machine according to the first embodiment of the present invention. FIG. 3 is a plan view of the packing 54 to be assembled into the processing machine according to the first embodiment of the present invention. FIG. 4 is a sectional view of the packing 54 to be assembled into the processing machine according to the first embodiment along IV-IV line in FIG. 3.

The processing machine according to the first embodiment detachably clamps the tool holder 10. The tool holder 10 also clamps the working tool 20 (or a machine tool) for cutting a work piece. The main spindle apparatus 30 rotates together with the tool holder 10 equipped with the working tool 20 in order to work the work piece.

That is, the main spindle part 41 in the main spindle apparatus 30 shown in FIG. 1 detachably and air-tightly clamps the tool holder 10. The main spindle part 41 is rotatably supported by a housing (not shown) of a cylindrical hollow shape. The main spindle part 41 is rotatably driven by a motor (not shown). The rotary shaft of the main spindle part 41 is held approximately parallel. A through hole 42 is formed along the rotary shaft in the main spindle part 41.

A holder clamping hole 44 is formed at a holder mounting part 43, placed at a front end part of the through hole 42 of the main spindle part 41. The tool holder 10 is clamped into the holder clamping hole 44 of the main spindle apparatus 30.

The inner peripheral surface 46 of the holder clamping hole 44 has a tapered shape, the diameter of which gradually increases toward the front-end direction (toward the left side of FIG. 1) of the main spindle part 41.

A ring-shaped end surface 45, which is perpendicular to the rotation shaft, is formed at the outside of the holder clamping hole 44.

A supporting member is placed in the through hole 42. The supporting member rotates together with the main spindle part 41 and supports a part of the tool holder 10 while maintaining the air-tightness of the lubricant passage in the processing machine.

As shown in FIG. 1, the supporting member is comprised mainly of a cylindrical sleeve 51, the clamping members 56, a helical extension spring 58, and a draw bar 59.

An operator operates the draw bar 59 to permit installation and removal of the tool holder 10 into/from the holder clamping hole 44. The draw bar 59 is placed along the rotary shaft of the main spindle apparatus 30.

The draw bar 59 is pushed toward the rear side of the main spindle part 41 by the spring applying force (or the spring energy) of the helical extension spring 58. The draw bar 59 has a through hole into which a lubricant supplying pipe 61 is placed and fitted. The through hole is formed along the rotary shaft in the draw bar 59.

The cylindrical sleeve 51 is attached to the front end part of the draw bar 59. A ring packing 53 made of rubber is placed at the outer peripheral surface of the cylindrical sleeve 51. The gap between the front end part of the sleeve 51 and a coolant hose 19 of the tool holder 10 is detachably sealed with the ring packing 53. This coolant hose 19 will be explained in detail.

The supporting member detachably supports a part (such as the coolant hose 19) of the tool holder 10 using the ring packing 53 to permit installation and removal of the tool holder under high air-tight condition.

A plurality of clamping members 56 is slidably placed at the outer periphery of the cylindrical sleeve 51, so facing the outer peripheral surface of the cylindrical sleeve 51. A locking member 57 is formed at the front end of each clamping member 56. The locking member 57 projects toward the outer periphery of the clamping member 56.

The clamping members 56 slide on the outer peripheral surface of the cylindrical sleeve 51. The locking part 57 of each clamping member 56 runs on a step part 52. Also, a locked member 16 of the tool holder 10 is stopped by the locking part 57, and the locked member 16 will be explained later.

On the other hand, the draw bar 59 and the cylindrical sleeve 51 are moved to the front end of the main spindle part 41 against the spring applying force of the helical extension spring 58, and the locking part 57 of each clamping member 56 runs on the step part 52, and then moves toward the rotary shaft side while sliding on the outer peripheral surface of the cylindrical sleeve 51. This releases the locked member 16 of the tool holder 10 from the locking part 57.

The lubricant supplying pipe 61 is inserted into the through hole 62 of the draw bar 59, through which oil mist as a cooling lubricant is transported to the working tool (as the machine tool). The lubricant supplying pipe 61 is fixed to a non-rotating part (not shown) of the main spindle apparatus 30, for example, through an O-ring and the like.

The lubricant supplying pipe 61 is rotatably supported by the cylindrical sleeve 51 through an oil-less bearing (not shown). It is also possible to have a structure in which the lubricant supplying pipe 61 is rotatably supported by the non-rotating part (not shown) of the main spindle apparatus 30 through a bearing.

The oil mist is transported from the rear side of the main spindle part 41 into the lubricant supplying pipe 61, and then flows toward the front end part of the lubricant supplying pipe 61 (namely, transported to the working tool).

A packing attachment part 55 is formed in the draw bar 59. The packing 54 is placed and fitted into the packing attachment part 55. This packing 54 is a leakage preventing member of a cylindrical shape as one of important features of the present invention. The packing attachment part 55 is a leakage preventing member attachment part.

That is, the packing 54 is placed between the draw bar 59 (that forms the supporting member) and the lubricant supplying pipe 61 in order to prevent the leakage of the oil mist as the cooling lubricant. It is preferable for the front end part of the lubricant supplying pipe 61 to have a tapered shape. This makes it possible to easily insert the front end part of the lubricant supplying pipe 61 into an opening of the packing 54. The packing 54 will be explained later in detail.

The tool holder 10 is a both surface attachment type (for example, HSK shank type, HSK type) which contacts with both the inner peripheral surface 46 and the end surface 45 of the holder clamping hole 44 when assembled into the main spindle part 41. The tool holder 10 has a holder main part 11 and an axial through hole 12. The axial hole is a through hole formed along the rotating axis of the holder main part 11. The oil mist flows from the lubricant supplying pipe 61 of the main spindle part 41 into the axial through hole 12 of the tool holder 10.

A taper part 15 is formed at one end of the holder main part 11 of the tool holder 10, at which the tool holder 10 is mounted to the main spindle part 41.

The taper part 15 has a cylindrical hollow shape that is so formed to project from the holder main part 11. A taper surface 15a is formed on the outer periphery of the taper part 15 and has a diameter which is almost equal in diameter to the holder main part 11 of the tool holder 10.

When the tool holder 10 is inserted into the holder clamping hole 44 of the main spindle part 41 in the main spindle apparatus 30, the taper surface 15a is contacted with and fitted to the inner peripheral surface 46 of the holder clamping hole 44.

The locked member 16 is formed at the front end of the taper part 15. The locked member 16 projects toward the inner periphery of the tool holder 10 and a partially thicker part. The locked member 16 has a ring shape, with which the locking part 57 of each clamping member 56 is locked.

The coolant hose 19 is formed in the hollow part at the inner periphery of the taper part 15. The coolant hose 19 has a cylindrical shape that projects from the bottom surface 18 toward the end side of the taper part 15 (toward the main spindle part 41 side).

The axial through hole 12 is formed in the inner periphery of the coolant hose 19. When the tool holder 10 is assembled into the main spindle part 41, the coolant hose 19 is inserted and fitted into the cylindrical sleeve 51 (through the packing 53), and the front end of the lubricant supplying pipe 61 is also inserted into the axial through hole 12 of the coolant hose 19.

The holder main part 11 has a flange part 14, the diameter of which is larger than that of the taper part 15. The flange part 14 is adjacent in position to the taper part 15 in the tool holder 10.

A ring-shaped end surface 17 adjacent to the taper part 15a in the flange part 14 of the tool holder 10 is formed to be approximately perpendicular to the rotary axis of the main spindle apparatus 30.

When the tool holder 10 is inserted into the holder clamping hole 44 of the main spindle part 41, the end surface 17 of the flange part 14 is contacted with the end surface 45 of the main spindle part 41 of the main spindle apparatus 30.

A working tool holding part 13 is formed at the other end part (at the left side in FIG. 1) of the holder main part 11 of the tool holder 10. The working tool holding part 13 holds the working tool 20. The working tool 20 works a work piece as a target to be processed.

An axial hole 22 is formed in a tool main part 21 of the working tool 20. The axial hole 22 is formed from the rear end part to the front end part of the working tool 20. When the working tool 20 is clamped by the working tool holding part 13 of the tool holder 10, the axial hole 22 formed in the working tool 20 and the axial hole 12 formed in the tool holder 10 are connected in a coaxial line in order to communicates with each other.

The oil mist flows from the lubricant supplying pipe 61 of the main spindle apparatus 30 to the axial hole 12 of the tool holder 10 and is supplied through the axial hole 22 to the front end side of the working tool 20.

Next, a description will now be given of the operation of the tool holder 10 and the main spindle apparatus 30 in the processing machine according to the first embodiment of the present invention.

When the processing machine processes a work piece, the main spindle part 41 and the tool holder 10 which clamps the working tool 20 rotate, but the lubricant supplying pipe 61 does not rotates because of being fixed to the non-rotating part (not shown) of the main spindle apparatus 30.

The oil mist supplied from the rear end part of the lubricant supplying pipe 61 flows into the front end part thereof (namely, to the working tool 20 side) without any effect of centrifugal force.

The oil mist flowing from the front end part of the lubricant supplying pipe 61 is transported to the front end part of the working tool 20 through the axial hole 12 of the tool holder 10 and the axial hole 22 of the working tool 20. The oil mist as the cooling lubricant lubricates and cools the working tool 20. In the processing machine according to the first embodiment of the present invention, the oil mist introduced from the rear end part of the lubricant supplying pipe 61 is transported to the working tool 20 without any effect of centrifugal force. This makes it possible to supply an adequate amount of the oil mist to the front end part of the working tool 20 in the processing machine.

A description will now be given of the packing 54 as the leakage preventing member of a cylindrical shape as one of important features of the present invention.

The tool holder 10 is a detachable member to the main spindle apparatus 30. That is, the tool holder 10 is replaced with another tool holder according to the work piece to be processed and the type of working tools.

In other words, the tool holder 10 mounted and clamped to the processing machine according to the first embodiment of the present invention corresponds to the tool holder based on HSK standard. When the tool holder 10 is mounted to the main spindle apparatus 30, one part (the front end part) of the lubricant supplying pipe 61 is placed in the inside of the coolant hose 19 of the tool holder 10. As shown in FIG. 1 and FIG. 2, this structure always requires the gap 190 between the inner peripheral surface of the coolant hose 19 and the outer peripheral surface of the lubricant supplying pipe 61. However, this structure of the processing machine has a drawback to leak the oil mist through the gap formed between the inner peripheral surface of the coolant hose 19 and the outer peripheral surface of the lubricant supplying pipe 61.

Usually, the oil mist flows toward the direction designated by the solid arrow shown in FIG. 2. When the diameter of the oil mist supplying hole at the front end part of the working tool 20 (namely, the diameter of the outlet of the oil mist) is adequately smaller than that of the lubricant supplying pipe 61, there is a possibility of the oil mist leaking toward the direction designated by the dotted arrow shown in FIG. 2 because of increasing the inner pressure of the lubricant supplying pipe 61 and axial holes 12 and 22.

The processing machine according to the first embodiment of the present invention uses the packing 54 in order to prevent the oil mist leaking through the gap between the draw bar 59 (that forms the supporting member) and the lubricant supplying pipe 61. This packing 54 serves as the lubricant leakage preventing member.

As shown in FIG. 3 and FIG. 4, the packing 54 is so designed that the more the stress generated by the leaking oil mist that leaks from the gap 190 (toward the opposite direction to the oil mist supplying direction) increases, the more the opening diameter of the packing 54 (the diameter of an opening part 540) is deformed to decrease. Specifically, the packing 54 is an elastic member of a ring shape having the opening part 540 through which the lubricant supplying pipe 61 is inserted.

As shown in FIG. 4, each end of the cross section of the packing 54 has a character ‘Y’ shape. That is, each end of the cross section of the packing 54 has a first hand 541 (as a sub-divided part), a second hand 542 (as a sub-divided part), and a groove 543. The first and second hands 541 and 542 (as the sub-divided parts) are divided by the groove 543. The packing 54 is placed in the packing attachment part 55 of the draw bar 59 so that the divided parts (composed of the groove part 543, the first hand 541, and the second hand 542) face the oil-mist supplying direction.

The first hand 541 is so placed, to be inclined to the oil mist supplying direction, between the draw bar 59 and the lubricant supplying pipe 61.

Unfortunately, even if the cooling lubricant such as oil mist leaks through the gap 190, the leaking oil mist contacts with the first hand 541 of the packing 54, and expands the first hand 541 (as one sub-divided part). This first hand 541 (as one sub-divided part) is expanded due to its own elasticity by hydraulic energy of the leaked oil mist (namely, the pressure of the leaked oil mist). The expansion of the first hand 541 increases the adhesion between the packing 54 and the lubricant supplying pipe 61. That is, the packing 54 always adheres to the lubricant supplying pipe 61 under the normal condition where no oil mist leaks through the gap 190. The more the oil mist as the cooling lubricant leaks through the gap 190, the more the adhesion between the packing 54 and the lubricant supplying pipe 61 increases, and the diameter of the opening of the packing 54 decreases. This improves the leakage preventing capability of the processing machine according to the first embodiment of the present invention.

On the other hand, the coolant hose 19 is air-tightly supported by the cylindrical sleeve 51 (serving as the component that forms the supporting member) through the packing 54. Even if the oil mist leaks through the gap 190, the leakage of the oil mist continues until the space 200 is filled with the leaked oil mist, but after filled with the leaking oil mist, there is no leakage of the oil mist. It is therefore possible to control the total amount of the leaking oil mist. This can supply or transport adequate amount of the oil mist to the working tool 20.

Further, the packing 54 rotates together with the main spindle apparatus 30, but the lubricant supplying pipe 61 does not rotate together with the main spindle apparatus 30. There is a possibility of decreasing the life time of the packing 54 when the packing 54 always adheres to the lubricant supplying pipe 61. Even if a small amount of the oil mist leaks through the gap 190, the leaking oil mist only has a weak pressure to expand the first hand 541, and this makes it possible for the oil mist to easily flow into the gap 190 between the packing 54 and the lubricant supplying pipe 61. A small amount of the leaking oil mist that is present in the gap 190 between the packing 54 and the lubricant supplying pipe 61 can extend the life time of the packing 54 because such a small amount of the leaking oil mist present between the gap 190 serves as the cooling lubricant.

There is no limitation of the position of the packing 54 to be placed as long as between the lubricant supplying pipe 61 and the draw bar 59 (that forms the supporting member). It is preferable to place the packing 54 near the coolant hose 19 between the lubricant supplying pipe 61 and the draw bar 59 (that forms the supporting member) because of decreasing the space area 200 (namely, in order to decrease the amount of the leaking oil mist).

### Second Embodiment

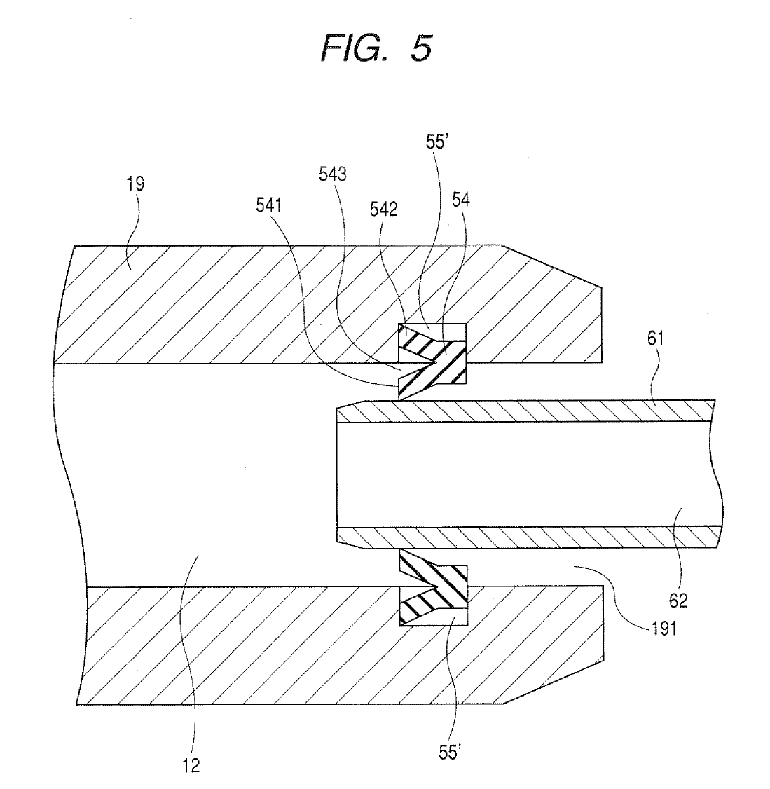

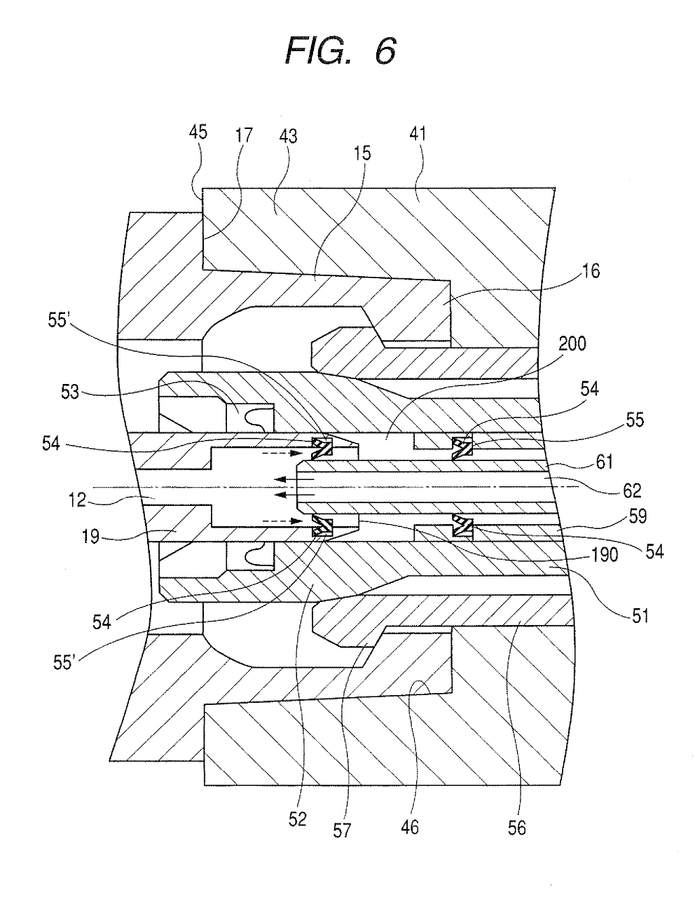

A description will be given of the processing machine according to the second embodiment of the present invention with reference to FIG. 5 and FIG. 6

FIG. 5 is an enlarged typical sectional view of the packing 54 and its peripheral parts in the processing machine according to the second embodiment of the present invention. FIG. 6 is an enlarged sectional view of another configuration of the packing and its peripheral parts in the processing machine according to the second embodiment of the present invention.

Since the processing machine according to the second embodiment is almost equal in structure to that of the first embodiment, the different feature between the first and second embodiments will be explained with reference to FIG. 5 and FIG. 6.

The different feature between the first and second embodiments is the position of the packing 54 (as the leakage preventing member).

In the processing machine according to the second embodiment, the packing 54 is placed at any position between the axial hole 12 and the lubricant supplying pipe 61. That is, the packing attachment part 55, is formed in the inner peripheral surface of the coolant hose 19, and the packing 54 is fitted to the packing attachment part 55′. This structure prevents the leakage of the oil mist through the gap 190.

The tool holder 10 is mounted on the main spindle apparatus 30, toward the opposite direction (toward the direction from left to right in FIG. 5) to the oil mist transporting direction. It is therefore preferable for the front end part of the lubricant supplying pipe 61 to have a taper part. This structure makes it possible to easily fit the tool holder 10 to the main spindle apparatus 30. Having the tapered front end part of the coolant hose 19 provides easy inserting of the coolant hose 19 into the sleeve 51.

On the other hand, having the tapered front end part of the lubricant supplying pipe 61 makes it possible to easily insert the lubricant supplying pipe 61 into the axial hole 12 of the tool holder 10.

As shown in FIG. 6, it is possible to place the additional packing 54 in the packing attachment part 55′ between the coolant hose 19 and the lubricant supplying pipe 61, in addition to the packing 54 placed in the packing attachment part 55 between the draw bar 59 (that forms the supporting member) and the lubricant supplying pipe 61. The pair of the packing 54 serves as the lubricant-leakage preventing member.

The structure of the processing machine according to each of the first and second embodiments uses the packing 54 with the character “Y” shape of the cross section. The concept of the present invention is not limited by this structure. It is acceptable to use any member capable of preventing the oil mist leakage such as an O-ring.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A processing machine comprising a main spindle apparatus and a tool holder, wherein
the main spindle apparatus detachably clamps the tool holder with a working tool, and rotates while clamping the tool holder, the main spindle apparatus comprising:
a main spindle part that is driven to rotate;
a through hole part that is formed along axis of rotation of the main spindle part;
a lubricant supplying pipe, placed in the through hole part, through which a cooling lubricant is transported to the working tool; and
a supporting member that rotates together with the main spindle part, and supports and air-tightly clamps a part of the tool holder,
and
the tool holder clamps the working tool which processes a work piece, the tool holder comprises:
a locked member that is formed at one end part of the tool holder, and is air-tightly clamped by the supporting member;
a holder main part that is formed at the other end part of the tool holder, and clamps the working tool; and
an axial hole that transports the cooling lubricant to the working tool, that is formed from one end part to the other end part of the tool holder along the rotary axis of the holder main part, and a front end part of the axial hole is inserted and fitted to the inside of the main spindle apparatus when the tool holder is clamped by the main spindle apparatus,
wherein a leakage preventing member of a ring shape capable of preventing leakage of the cooling lubricant is placed at least one of between the supporting member and the lubricant supplying pipe and between the axial hole of the tool holder and the lubricant supplying pipe.

2. The processing machine according to claim 1, wherein the leakage preventing member of a ring shape has an opening part, and deforms to decrease the diameter of the opening part as the force applied by the cooling lubricant increases.

3. The processing machine according to claim 2, wherein the leakage preventing member has a divided part comprised of at least two divided sub-parts, the divided part is placed to face the supplying direction of the cooling lubricant, and at least one divided sub-part is inclined to the supplying direction of the cooling lubricant.

4. The processing machine according to claim 1, wherein the leakage preventing member is composed of an O-ring.

5. The processing machine according to claim 1, wherein the leakage preventing member is placed and fitted in a leakage preventing member attachment part of a groove shape.

6. The processing machine according to claim 1, wherein the leakage preventing member is made of an elastic member.

7. The processing machine according to claim 1, wherein the leakage preventing member rotates together with the main axial apparatus.
